(19) United States
(12) Patent Application Publication
(10) Pub. No.: US 2021/0287067 A1
(43) Pub. Date: Sep. 16, 2021

(54) EDGE MESSAGE PASSING NEURAL NETWORK

(71) Applicant: Insilico Medicine IP Limited, Hong Kong (HK)

(72) Inventors: Aleksandrs Zavoronkovs, Pak Shek Kok (HK); Evgeny Olegovich Putin, Saint Petersburg (RU); Dmitry Leonov, Tambov (RU)

(21) Appl. No.: 17/198,057

(22) Filed: Mar. 10, 2021

Related U.S. Application Data
(60) Provisional application No. 62/988,182, filed on Mar. 11, 2020.

(51) Int. Cl. G06N 3/04; G06N 3/08

(52) U.S. Cl. CPC G06N 3/0445; G06N 3/08

(57) ABSTRACT

A method of generating graph data of an object is provided, the object is physical, audio object, text object or color object. The method can include: processing input graph data of at least one object with a graph convolution layer of an edge message passing neural network to obtain vector representations of the node data and edge data of the graph data; processing the vector representations of the edge data and node data with a graph pooling layer of the edge message passing neural network that aggregates the vector representations of the node data and the vector representations of edge data to produce a vector representation of the input graph data; processing the vector representation of the input graph data with a multi-layer perception layer of the edge message passing neural network to generate predicted graph data of a predicted object; and reporting the predicted graph data in a report.

### CROSS-REFERENCE TO RELATED APPLICATIONS

This patent application claims priority to U.S. Provisional Application No. 62/988,182 filed Mar. 11, 2020, which provisional is incorporated herein by specific reference in its entirety.

### BACKGROUND

### Field

The present disclosure relates to an edge message passing neural network. More particularly, the present disclosure relates to using an edge message passing neural network for generating graph data, such as physical objects (e.g., molecules), visual objects (e.g., color, images, video), or audio objects (e.g., sound) represented by graph data.

### Description of Related Art

Artificial Neural Networks (ANNs) are a subclass of machine learning models inspired by biological neural networks. ANNs include artificial neurons, which can be configured as simple connected units or nodes, which are able to receive, process and transmit a signal. Generally, an artificial neuron of an ANN receives input signal represented as N-dimensional real-valued vector, multiplies it by a neuron weight, which adjusts during training procedure, and outputs a sum of multiplication results with an applied nonlinear function, such as hyperbolic tangent or rectified linear unit (ReLU; e.g., a function defined as the positive part of an argument). Despite simplicity, when combined into a large network those units can be used for solving complex artificial intelligence tasks, such as regression, classification, generation. Each ANN has input layers, hidden layers, and output layers. ANNs with one or more hidden layers are called Deep Neural Networks (DNNs). Simple feed-forward DNNs are usually defined as a Multilayer Perceptron (MLP) or Fully Connected Neural Network (FCNN).

ANNs require machine learning for a good performance on a specific task. It means that the network should generalize knowledge obtained from sample observations on an independent test subset. This might be achieved by minimizing the observed errors that are aggregated in a loss function, which a user selects manually such as mean squared error, for regression tasks or binary cross-entropy for classification tasks. Usually, Stochastic Gradient Descent (SGD) based methods are utilized to minimize a loss function. In this case, the backpropagation algorithm is used to compute a gradient of a loss function with respect to training samples. Then, ANN weights are updated proportional to the negative of the gradient where the manually chosen coefficient of the proportionality is called the learning rate. This process is repeated until the convergence of the model. A validation step is often used to evaluate model performance on unseen data or to implement an early stop to the training. On the test stage, a trained model predicts labels for unseen samples from the test set.

In a fully connected ANN, each neuron is connected to every neuron from the previous layer. However, it is not reasonable to apply this architecture to tasks where the input size could be large, such as in image processing. In contrast to fully connected ANN, Convolutional Neural Networks (CNNs) apply a convolution operation to the input data. More precisely, CNNs have a weight matrix of fixed size (e.g., convolutional kernel) that shifts by a small step on the whole input and calculates the sum of a Hadamard product of the kernel weights and corresponding input signal with nonlinearity applied on each step.

Often, pooling is applied to reduce the input dimension and to speed up the training process. Local pooling combines outputs obtained from a grid of neurons (e.g., usually 2×2) from one layer into a single neuron to the next layer. Global pooling combines all neurons from one convolutional layer. Typically, both pooling methods apply a simple permutation invariant function to its inputs, such as max, sum or average.

Recurrent Neural Networks (RNNs) use their internal state to process sequences of inputs. Gated Recurrent Units (GRUs) extend RNNs with a gating mechanism that leverages the information passed to the output. The main property of GRUs is that they are able to keep the information from several past steps.

A graph can refer to an abstract mathematical structure, which is represented as a set of vertices (nodes) and a set of links between those nodes (edges). Graph Neural Networks (GNNs) are ANNs which operate on graph structured data.

Motivated by the success of CNNs, the graph convolution operation (GC) is an extension of the convolution operation on graphs. For instance, an image can be represented as a graph, where pixels are nodes and each pixel is connected to its adjacent one through edges. Similar to convolution in CNNs, graph convolution aggregates a node neighborhood signals, which are the neighboring signals of a particular node. ANNs that employ a graph convolution operation are called Convolutional Graph Neural Networks (ConvGNNs). ConvGNNs fall into two major classes: (1) spectral-based; and (2) spatial-based.

Spectral-based ConvGNNs originated from graph signal processing. Assuming graphs to be undirected, spectral-based ConvGNNs introduce a graph Fourier transform and an inverse graph Fourier transform to define graph convolution. The graph Fourier transform maps the graph input signal into the orthonormal space with a basis obtained from eigenvectors of the symmetric normalized graph Laplacian.

Spatial-based ConvGNNs define graph convolution operation for specific node as an aggregation of its own signals and adjacent node signals. Although spectral-based ConvGNNs have strong theoretical fundamentals, spatial-based ConvGNNs can be preferred due to their efficiency, versatility and scalability. Unlike spectral-based models, spatial-based ConvGNNs do not require to compute the graph Laplacian and its decomposition, which is usually costly. Also, spatial-based ConvGNNs are not limited to undirected graphs, and may be extended to handle additional information, such as edge attributes.

Message Passing Neural Networks (MPNN) introduce a general framework for ConvGNNs by considering a graph convolution as a two-step operation. First, message function is applied to a specific node and its k-hop neighborhood of nodes, then an update function, which is usually permutation invariant, transfers aggregated information from such neighborhood nodes back to the selected node. For graph-level tasks, such as graph classification or regression, the readout function is commonly applied to obtain a graph representation from node representations. Similar to global pooling in CNNs, this function must be permutation invariant, thus it is often referred to as global graph pooling. Usually, the readout function is a sum, max or average of node signals.

### SUMMARY

In some embodiments, a computer-implemented method of generating graph data can include: processing input graph data with a graph convolution layer of an edge message passing neural network to obtain vector representations of the node data and edge data of the graph data; processing the vector representations of the edge data and node data with a graph pooling layer of the edge message passing neural network that aggregates the vector representations of the node data and the vector representations of edge data to produce a vector representation of the input graph data; processing the vector representation of the input graph data with a multi-layer perception layer of the edge message passing neural network to generate predicted graph data; and outputting the predicted graph data in a report.

In some embodiments, a computer-implemented method of generating graph data of an object is provided, wherein the object is a physical object, an audio object, a text object or a color object. The method can include: processing input graph data of at least one object with a graph convolution layer of an edge message passing neural network to obtain vector representations of the node data and edge data of the graph data; processing the vector representations of the edge data and node data with a graph pooling layer of the edge message passing neural network that aggregates the vector representations of the node data and the vector representations of edge data to produce a vector representation of the input graph data; processing the vector representation of the input graph data with a multi-layer perception layer of the edge message passing neural network to generate predicted graph data of a predicted object; and putting the predicted graph data in a report.

In some embodiments, a graph neural network encoder of the graph convolution layer produces a vector representation for each node of the input graph and a vector representation for each edge of the input graph.

In some embodiments, the method can include processing the input graph data to produce a vector representation for each node and a vector representation for each edge of the graphs.

In some embodiments, the method can include processing the input graph data to produce a vector representation of the graphs.

In some embodiments, the method can include processing the input graph data to produce a vector representation for each pair of nodes of the graphs.

In some embodiments, the method can include processing the input graph data to produce a vector representation for each pair of edges of the graphs.

In some embodiments, the method can include processing the input graph data with the graph neural network encoder in accordance with at least one of: a node message neural network producing a vector representation for each pair of adjacent nodes based upon the vector representations of each node of the pair of adjacent nodes and a vector representation of each edge connecting the pair of adjacent nodes; a node update neural network producing a vector representation of a node based upon a node representation and message vectors for node pairs formed by the node and its adjacent nodes; an edge message neural network producing a vector representation for each pair of adjacent edges based upon the vector representations of each edge of the pair of adjacent edges and a vector representation of the common node of the pair of adjacent edges; or an edge update neural network producing a vector representation of an edge based upon a node representation and message vectors for edge pairs formed by the edge and its adjacent edges.

In some embodiments, the graph pooling layer aggregates the vector representations of nodes and the vector representations of edges to produce a vector representation of the input graph.

In some embodiments, the node update neural network is configured for one of a sum, max, or average.

In some embodiments, the node update neural network is configure for a weighted sum comprising an attention-based weighted sum.

In some embodiments, the node update neural network is a recurrent neural network.

In some embodiments, the edge update neural network is configured for one of a sum, max or average.

In some embodiments, the edge update neural network is configured for a weighted sum comprising an attention-based weighted sum.

In some embodiments, the edge update neural network is a recurrent neural network.

In some embodiments, the EMPNN includes a generator that produces graphs from random noise.

In some embodiments, the at least one object is a picture (e.g., color object), text (e.g., text object), molecule (e.g., physical object), sound (e.g., audio object), video (e.g., series of color object and optionally with sound object), or other object.

In some embodiments, the graph convolution layer module can perform: processing the input graph data with a conversion operation; converting input graph edges into new nodes; constructing new edges to obtain resulting graph data; and applying a messaging passing protocol with the resulting graph data.

In some embodiments, the graph pooling layer module performs: receiving edge features and node features as vectors; and performing graph embedding of the vectors to produce a vector representation of new graph data.

In some embodiments, a method of preparing providing an object is provided. In some aspects, object is a physical object, an audio object, a text object or a color object. The method can include: obtaining a predicted graph data; preparing the predicted graph data into a predicted object, wherein the predicted object is a physical object, an audio object, a text object or a color object.

In some embodiments, a computer system can include: one or more processors; and one or more non-transitory computer readable media storing instructions that in response to being executed by the one or more processors, cause the computer system to perform operations. In some aspects, the operations can include: processing input graph data with a graph convolution layer of an edge message passing neural network to obtain vector representations of the node data and edge data of the graph data; processing the vector representations of the edge data and node data with a graph pooling layer of the edge message passing neural network that aggregates the vector representations of the node data and the vector representations of edge data to produce a vector representation of the input graph data; processing the vector representation of the input graph data with a multi-layer perception layer of the edge message passing neural network to generate predicted graph data; and outputting the predicted graph data in a report.

In some embodiments, one or more non-transitory computer readable media storing instructions that in response to being executed by the one or more processors, cause the computer system to perform operations are provided. The operations can include: processing input graph data with a graph convolution layer of an edge message passing neural network to obtain vector representations of the node data and edge data of the graph data; processing the vector representations of the edge data and node data with a graph pooling layer of the edge message passing neural network that aggregates the vector representations of the node data and the vector representations of edge data to produce a vector representation of the input graph data; processing the vector representation of the input graph data with a multi-layer perception layer of the edge message passing neural network to generate predicted graph data; and outputting the predicted graph data in a report.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

The foregoing and following information as well as other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings.

FIG. 1A includes a schematic representation of the proposed model architecture for the edge message passing neural network. All the modules are applied sequentially to the input graph.

FIG. 1B includes a flow chart illustrating a method performed by the graph convolution layer module. First, the graph convolution layer module constructs a line graph from each input graph. Then, the graph convolution layer module applies a message passing procedure on both input graphs and corresponding line graphs.

FIG. 1C includes a flow chart illustrating a method performed by the graph pooling layer module. The graph pooling layer module receives node and edge representations, aggregates them into two vectors and concatenates those vectors.

FIG. 1D includes a schematic representation of an embodiment of an edge message passing neural network.

FIG. 2 includes a flowchart of the model training process of the edge message passing neural network.

FIG. 3 includes a flowchart of the process for preparing predicted labels with the edge message passing neural network.

FIG. 4 includes a flowchart of the message passing layer of the graph convolution layer.

FIG. 5 includes a flowchart of the graph pooling layer.

FIG. 6 includes a schematic representation of a computing system that can perform the computer-implemented methods described herein.

The elements and components in the figures can be arranged in accordance with at least one of the embodiments described herein, and which arrangement may be modified in accordance with the disclosure provided herein by one of ordinary skill in the art.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

Generally, the present disclosure relates to an edge message passing neural network (EMPNN) configured to receive graph data of at least one graph and generate predicted graph data based on the received graph data, and which is different from the received graph data. For example, the graph data can include one or more molecules, and the predicted graph data can provide one or more molecules based on the input molecules but that are different from the input molecules. Thereby, the predicted graph data, sometimes referred to as a predicted label, can be similar to the input graph data but characteristically different in some way from the input graph data. That is, the predicted graph data can be new graph data compared to the input graph data.

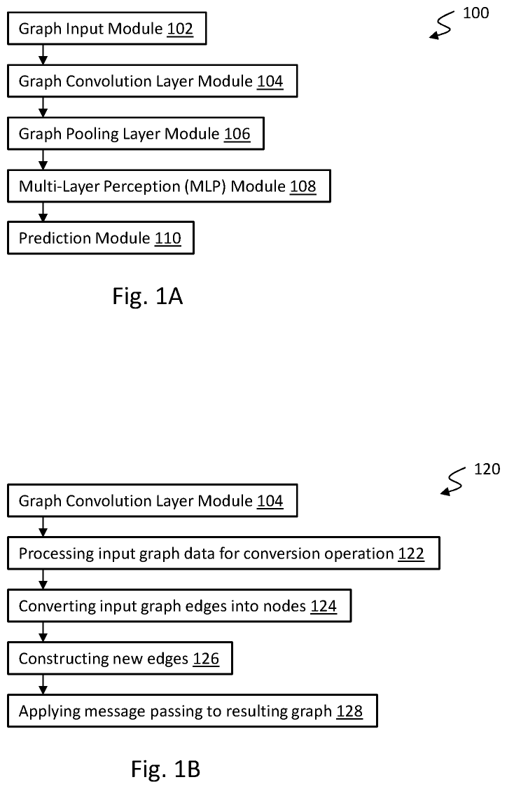

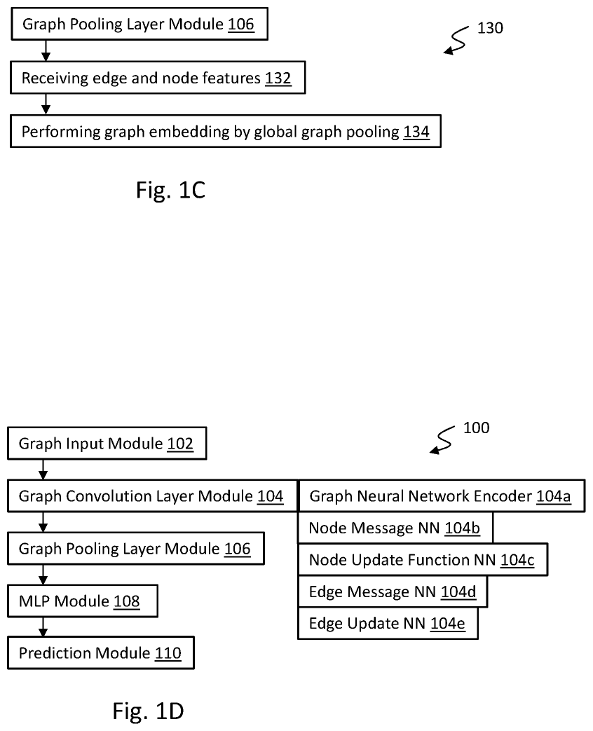

FIG. 1A illustrates an embodiment of architecture of an Edge Message Passing Neural Network (EMPNN) 100. The EMPNN 100 is shown to have a graph input module 102 that is adapted for operation with graph data. The graph data is an abstract mathematical structure that is represented as a set of vertices (nodes) and a set of links between those nodes (edges). Accordingly, the EMPNN 100 may be considered to be a GNN. The graph input module 102 can perform operations with input graph data, such as storing, accessing, and passing the graph data to a graph convolution layer module 104.

The graph convolution layer module 104 is configured to operate as a graph convolution layer to perform graph convolution (GC) operations on the graph data. The GC operation can include an extension of convolution operation on graph data. For example, an image can be represented as a graph, where pixels are nodes and each pixel is an edge connected to its adjacent pixel. The GC operation aggregates a node's neighborhood signals. All the modules are applied sequentially to the input graph data.

The graph convolution layer module 104 is configured to participate in edge message passing 120 as shown in FIG. 1B. The edge message passing can include processing the input graph data so that there is a conversion operation (block 122) of: converting input graph edges into nodes (block 124); constructing new edges according to the edge adjacency matrix in the input graph (block 126) to obtain a resulting graph; and applying message passing to the resulting graph (block 128). Accordingly, information related to pairs of edges can be passed to the model.

In some aspects, an attention mechanism can be used in the graph convolutional layer module 104 to impose it to learn important interrelations between atom pairs. The node and edge updates can be formulated to update the graph data. The attention mechanism allows ANNs to attend to different parts of input signals that it considers more relevant. After its success in Natural Language Processing tasks, this technique is widely used in modern ANNs. First, the graph convolution layer module constructs a line graph from each input graph (blocks 122, 124, and 126). Then, the graph convolution layer module applies a message passing procedure on both input graphs and corresponding line graphs (block 128).

The graph pooling layer module 106 can be configured to perform processing of edge features, such as for the protocol 130 of FIG. 1C. The processing can include the graph pooling layer module 106 receiving edge features and node features that yield more accurate graph embedding (block 132). Constructing graph embedding by graph pooling is performed (block 134). Then, the graph embedding is provided to the MLP module 108. The graph pooling layer module receives node and edge representations (block 132), aggregates them into two vectors and concatenates those vectors (block 134).

As indicated in FIG. 1A, the MLP module can be configured as a feedforward ANN, and it can have multiple layers of preceptrons. Each perceptron is an algorithm for supervised learning of binary classifiers. A binary classifier is a function which can decide whether or not an input, represented by a vector of numbers, belongs to some specific class. An MLP can include at least three layers of nodes: an input layer, a hidden layer and an output layer. Since MLPs are fully connected, each node in one layer connects with a certain weight to every node in the following layer. Except for the input nodes, each node is a neuron that uses a nonlinear activation function. MLP utilizes a supervised learning technique called backpropagation for training. Its multiple layers and non-linear activation distinguish MLP from a linear perceptron, and can distinguish data that is not linearly separable.

If a multilayer perceptron has a linear activation function in all neurons, that is, a linear function that maps the weighted inputs to the output of each neuron, then linear algebra shows that any number of layers can be reduced to a two-layer input-output model. In MLPs some neurons use a nonlinear activation function that was developed to model the frequency of action potentials, or firing, of biological neurons. Learning occurs in the perceptron by changing connection weights after each piece of data is processed, based on the amount of error in the output compared to the expected result. This is an example of supervised learning, and is carried out through backpropagation, a generalization of the least mean squares algorithm in the linear perceptron.

The output of the MLP module 108 can be a prediction of new graph data (e.g., predicted label). The output prediction can be provided to the prediction module 110. The prediction module 110 can control performance of various data processing actions with the predicted new graph data, such as displaying on a display, saving into a database, compiling into a report, providing a report, transmitting to another module, or any other action. The prediction module 110 can provide the new graph data, such as a molecule, so that the chemical structure of the molecule is known. Then, synthesis of the molecule can be determined and performed to yield a real example molecule.

FIG. 1D shows an embodiment of the Edge Message Passing Neural Network (EMPNN) 100 of FIG. 1A. As shown, the graph convolution layer module 104 can include a graph neural network encoder 104a, a node messaging neural network (NN) 104b, a node update function neural network 104c, an edge message neural network 104d, and an edge update neural network 104e.

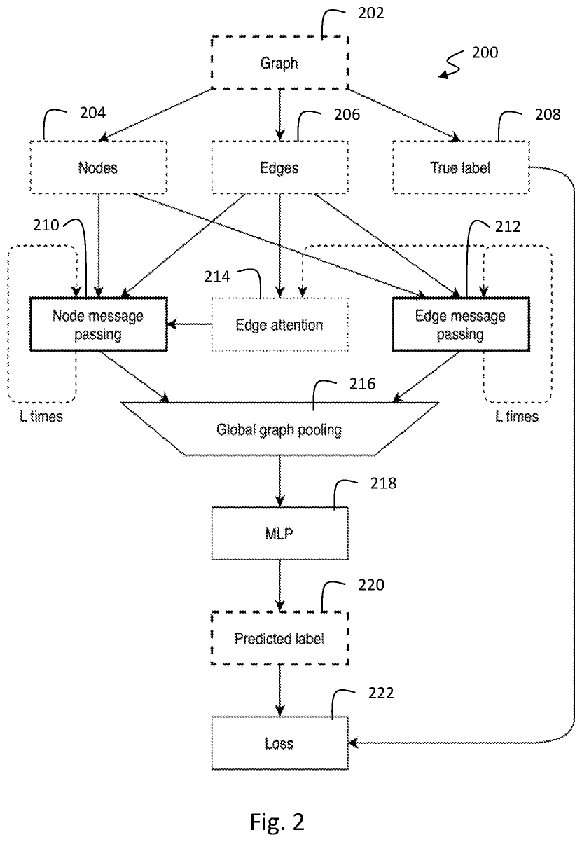

FIG. 2 illustrates a training method 200 that can be used for training the model. As shown, the graph data is provided at block 202 and processed into node data (block 204), edge data (block 206), and a true label (block 208). The node data 204 can be processed by node message passing at block 210, which can be performed in an iteration L times, where L is a reasonable number. The edge data 206 can be processed by edge message passing at block 212, which can be performed in an iteration of L times, wherein L is a reasonable number and may be the same or different from the node message passing 210 L iterations. In some instances, transformations can be performed on the graph data. The node data 204 may be transformed into edge data and processed with the edge message passing 212. The edge data 206 may be transformed into node data and processed with the node message passing 210. The message passing can be performed L iterations.

The edge data 206 and data from the edge message passing 212 can then be treated with an edge attention mechanism 214. The edge attention mechanism 214 can be used in the graph convolutional layer to impose it to learn important interrelations between atom pairs. The outcome of the edge attention mechanism 214 is provided to the node message passing 210, which can be part of each iteration.

The output from the node message passing 210 and the edge message passing 212 can then be processed for global graph pooling 216. The graph embedding can be obtained via the global graph pooling 216, and provided to the MLP 218 (e.g., DNN). The MLP 218 can then provide the specific output of the predicted label 220. The predicted label 220 can then be compared to the true label 218 to compute the loss 222.

In some embodiments, the training is performed with a SGD algorithm using an Adam optimizer. For each iteration of SGD the following steps are performed (Step 1): (a) Split dataset into train, validation and test sets; (b) Sample a minibatch of molecules represented as graphs; (c) Apply some transformation on sampled graphs, if necessary; (d) Perform message passing step on nodes and edges; (e) Repeat step (d) L times; (f) Obtain graph embedding via the proposed global graph pooling; (g) Add graph-level features if they exists; (h) Apply DNN to obtain specific output; (i) Compute loss between the true label and the predicted label one on step (f) or step (g) or step (h); (j) Perform the gradient descent step using loss from (i). Steps (1d)-(1i) are shown on FIG. 2. Then, the protocol can evaluate model on the validation set (Step 2). The learning rate can then be adjusted according to a chosen policy (Step 3). If a target metric does not improve after n epochs, protocol can stop the training process (Step 4). The protocol can be repeated by repeating Steps (1)-(4) until convergence. The model can then be evaluated on the test set to obtain final metrics. Then, a report having the final metrics and/or trained model can be provided. The report can be any type of report.

In some embodiments, the embedding is a continuous vector representation of a discrete variable.

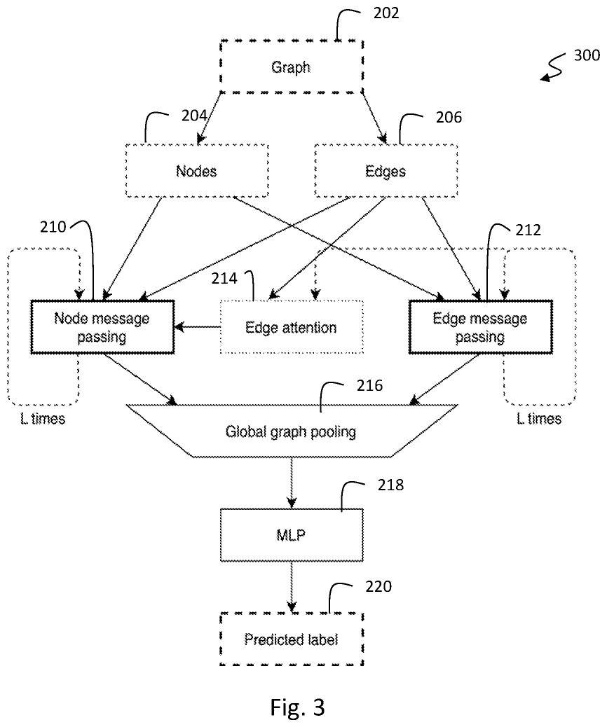

FIG. 3 shows a method 300 of obtaining a predicted label (e.g., object), which is a predicted graph data from the input graph data. The method 300 can include the following. As shown, the graph data is provided at block 202 and processed into node data (block 204) and edge data (block 206). The node data 204 can be processed by node message passing at block 210, which can be performed in an iteration L times, where L is a reasonable number. The edge data 206 can be processed by edge message passing at block 212, which can be performed in an iteration of L times, wherein L is a reasonable number and may be the same or different from the node message passing 210 L iterations. In some instances, transformations can be performed on the graph data. The node data 204 may be transformed into edge data and processed with the edge message passing 212. The edge data 206 may be transformed into node data and processed with the node message passing 210. The message passing can be performed L iterations.

The edge data 206 and data from the edge message passing 212 can then be treated with an edge attention mechanism 214. The edge attention mechanism 214 can be used in the graph convolutional layer to impose it to learn important interrelations between atom pairs. The outcome of the edge attention mechanism 214 is provided to the node message passing 210, which can be part of each iteration.

The output from the node message passing 210 and the edge message passing 212 can then be processed for global graph pooling 216. The graph embedding can be obtained via the global graph pooling 216, and provided to the MLP 218 (e.g., DNN). The MLP 218 can then provide the specific output of the predicted label 220.

In some embodiments, the determination of a predicted label, which is a predicted graph data of the predicted label, can be performed with a trained model, such as per FIG. 2. The generation of a predicted label of graph data can be performed with the following steps (Step 1): (a) Sample a minibatch of molecules represented as graphs; (b) Apply some transformation on sampled graphs, if necessary; (c) Perform message passing step on nodes and edges; (d) Repeat step (d) L times; (e) Obtain graph embedding via the proposed global graph pooling; (f) Add graph-level features if they exists; and (g) Apply DNN to obtain specific output. Steps (1a)-(1g) are shown on FIG. 3. The prediction of the molecular properties of molecules represented as graphs is performed using the procedure shown on FIG. 3.

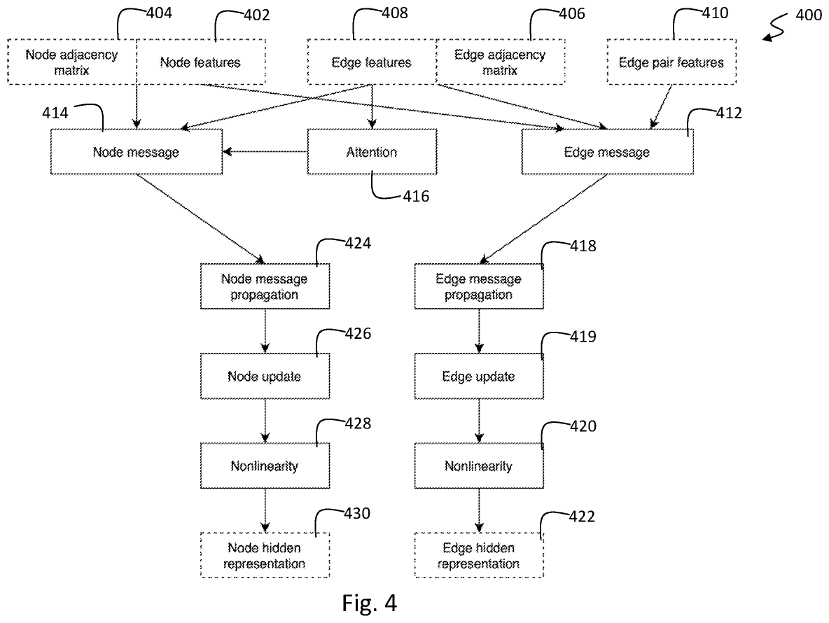

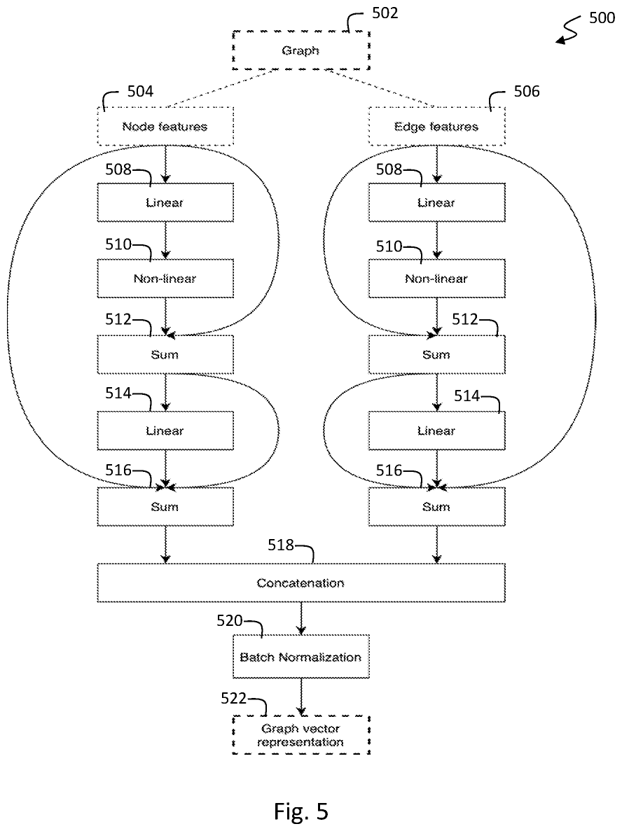

FIG. 4 shows operation 400 of the graph convolution layer module 104, such as the message passing layer. The node features 402 are converted edge features and edge messaging is applied (block 412) as shown by the arrow. The node adjacency matrix is applied at block 404 and the information therefrom is obtained and node messaging is applied at block 414. Also, the edge features 408 are converted to node features and node messaging is applied (block 414) as shown by the arrow. The edge adjacency matrix is applied at block 406 and the information therefrom is obtained and edge messaging is applied at block 412. Additionally, edge pair features are obtained (block 410) and then processed by edge messaging 412. The edge features 408 are processed with the attention mechanism to impose learning of interrelations between atom pairs. The information from the attention mechanism is processed with the node messaging at block 414.

The outcome from the edge messaging 412 is then processed by edge message propagation at block 418. Then, an edge update is performed at block 419. A nonlinearity is then applied at block 420. Then, the edge hidden representation is obtained at block 422.

The outcome from the node messaging 414 is then processed by node message propagation at block 424. Then, a node update is performed at block 426. A nonlinearity is then applied at block 428. Then, the node hidden representation is obtained at block 430.

FIG. 5 shows a method 500 for obtaining a graph vector representation with the graph pooling layer. The method 500 shows obtaining graph data 502 and then obtaining the node features 504 and edge features 506. The node features 504 and edge features 506 are then processed with the following: a linearization at block 508; a non-linearization at block 510; a sum is calculated at block 512; a linearization at block 514; and a sum is calculated at block 516. The sums of the node feature protocol and edge feature protocol are then processed through a concatenation at block 518. A batch normalization is performed at block 520. Batch normalization (BN) is a technique for improving the stability and speeding up the training process. It employs the normalization step on a small subset (batch) of data which fixes the means and variances of layer's inputs. A graph vector representation 522 is then obtained.

Graph-level regression and classification (e.g., graph-level tasks) are the most common tasks in deep learning on graph-structured data. GNNs are applied to molecular properties prediction and image classification. More precisely, an image can be represented as a graph with pixel clustering algorithms or just by connecting adjacent pixels and fed to GNN. For example, graph classification task is to predict whether is the compound active or not and graph regression task is to predict the log-solubility of the compound. The proposed model can be applied to aforementioned tasks and might be extended to incorporate graph-level features (e.g., various molecular descriptors concatenated to the graph representation obtained from GNN for further processing).

Edge classification, edge regression and link prediction (e.g., edge-level tasks) are common edge-level tasks in graph representation learning. Link prediction is a task to estimate a probability of edge existence between a pair of nodes. Edge classification is a task to predict a categorical label referring to an edge in the graph. (e.g. the relationship type between two users in a social network). Edge regression is a task to estimate a continuous value referring to an edge in the graph (e.g. traffic size on the road part between two crossings in case of traffic network). Link prediction is a task to estimate a probability of an edge existence between a pair of nodes. (e.g. existence of a relationship between two users in a social network). In link prediction the real structure is unknown unlike in link classification. These tasks take place in social network analysis, traffic forecasting and recommender systems. The edge-level EMPNN is able to construct informative edge representations by utilizing adjacent edge and pair edge information.

The proposed model can be used to solve node classification and node regression tasks. Node-level tasks consists in predicting a categorical label in case of classification or a continuous value in case of regression. Thus, EMPNN can be utilized for analyzing social and citation graphs. For example, a social network consists of nodes—users and relations between them (e.g. friends, colleagues, etc.) can be represented as edges. In this case node regression task might be predicting each user's page traffic and edge regression task might be predicting user's gender. High-level node representations can be obtained through EMPNN node message passing and edge message steps. The node-level EMPNN is trained using the following SGD-based algorithm.

1. For each iteration of SGD the following steps are performed:
a. Split dataset into train, validation and test sets;
b. Sample a minibatch of molecules represented as graphs;
c. Apply some transformation on sampled graphs if necessary;
d. Perform message passing step on nodes and edges;
e. Repeat step (d) L times;
f. Obtain graph embedding via the proposed global graph pooling;
g. Add graph-level features if exist;
h. Apply DNN to obtain specific output;
i. Compute loss between the true label and the one on step (f) or step (g) or step (h);
j. Perform the gradient descent step using loss from (i)

2. Evaluate model on the validation set

3. Adjust learning rate according to chosen policy

4. If a target metric does not improve after n epochs, stop training process

5. Repeat (1)-(4) until convergence

6. Evaluate model on the test set to obtain final metrics

In some embodiments, a computer implemented neural network system can include one or more graph convolutional neural networks (e.g., graph convolution layer module) configured to: process an input data represented as one or more graphs to produce a vector representation for each node and a vector representation for each edge of the graphs; process an input data represented as one or more graphs to produce a vector representation of the graphs; process an input data represented as one or more graphs to produce a vector representation for each pair of nodes of the graphs; and process an input data represented as one or more graphs to produce a vector representation for each pair of edges of the graphs. In some aspects, the one or more graph convolutional neural networks can include a graph neural network encoder (e.g., part of the graph convolution layer module 104 or a separate module—graph neural network encoder 104a—FIG. 1D) that processes an input graph to produce a vector representation for each node of the input graph and a vector representation for each edge of the input graph. In some aspects, the one or more neural networks can include a graph pooling (e.g., graph pooling layer module 106—FIG. 1D) that aggregates the vector representations of nodes and the vector representations of edges to produce a vector representation of the input graph. It should be recognized that the training procedure can be employed for generation of a predicted label, and the generation of the object can be from step b) to step h).

In some embodiments, a graph neural network encoder of the one or more neural networks can include: a node message neural network (FIG. 1D—104b) that produces a vector representation for each pair of adjacent nodes based upon a vector representations of such nodes and a vector representation of an edge connecting such nodes; and a node update function (FIG. 1D—104c) having a neural network that produces a vector representation of a node based upon a particular node representation and message vectors for node pairs formed by such node and its adjacent nodes; an edge message neural network (FIG. 1D—104d) that produces a vector representation for each pair of adjacent edges based upon a vector representations of such edges and a vector representation of their common node; and an edge update function (FIG. 1D—104e) comprising neural network which produces a vector representation of an edge based upon a particular node representation and message vectors for edge pairs formed by such edge and its adjacent edges.

In some embodiments, the graph neural network encoder comprises a plurality of hidden layers and activation functions. In some aspects, the one or more of the plurality of the hidden layers represent skip connections. In some aspects, the node update function is a sum, max or average. In some aspects, the node update function is a weighted sum comprising attention-based weighted sum. In some aspects, the node update function is a recurrent neural network. In some aspects, the edge update function is a sum, max or average.

In some embodiments, the edge update function is a weighted sum comprising an attention-based weighted sum. In some aspects, the edge update function is a recurrent neural network.

In some embodiments, the graph pooling comprises a plurality of hidden layers and activation functions.

In some embodiments, a neural network can include a decoder that is configured to reconstruct the input data represented as one or more graphs from the graph vector representation.

In some embodiments, a neural network can include a generator that produces graphs from random noise.

In some embodiments, a method of generating an object with an edge message passing neural network can include: providing a computing system having the edge message passing neural network that comprises a graph convolutional layer, global graph pooling layer, and multi-layer perception layer; inputting graph data into the graph convolution layer to obtain new node data and edge data of the input graph data; inputting the new edge data and/or node data into the graph pooling layer to obtain to obtain a graph embedding data; inputting the graph embedding data into the multi-layer perception layer to generate a predicted graph data; and outputting the predicted graph data in a report.

In some embodiments, the graph data is molecule data, and the predicted graph data is a predicted molecule chemical structure.

In some embodiments, the graph convolution layer can process the input data, in the computing system, wherein the input data is represented as one or more graphs to produce a vector representation for each node and a vector representation for each edge of the graphs. In some aspects, the graph convolution layer can process the input data, the input data being represented as one or more graphs to produce a vector representation of the graphs. In some aspects, the graph convolution layer can process the input data, in the computing system, the input data being represented as one or more graphs to produce a vector representation for each pair of nodes of the graphs. In some aspects, the graph convolution layer can process the input data represented as one or more graphs to produce a vector representation for each pair of edges of the graphs.

In some embodiments, the graph convolutional layer is configured as a graph neural network encoder, which processes the input graph to produce a vector representation for each node of the input graph and a vector representation for each edge of the input graph.

In some embodiments, the graph pooling layer is configured to aggregate the vector representations of nodes and the vector representations of edges to produce a vector representation of the input graph.

In some embodiments, the graph convolution layer module can have different neural networks. In some aspects, a node message neural network can be configured to produce a vector representation for each pair of adjacent nodes based upon a vector representations of such nodes and a vector representation of an edge connecting such nodes. In some aspects, an edge message neural network can be configured to produce a vector representation for each pair of adjacent edges based upon a vector representations of such edges and a vector representation of their common node.

In some aspects, a node update function can include a node update neural network that produces a vector representation of a node based upon a particular node representation and message vectors for node pairs formed by such node and its adjacent nodes. In some aspects, the node update function is a sum, max or average. In some aspects, the node update function is a weighted sum comprising attention-based weighted sum. In some aspects, the node update function is a recurrent neural network.

In some embodiments, an edge update function can include an edge update neural network that produces a vector representation of an edge based upon a particular node representation and message vectors for edge pairs formed by such edge and its adjacent edges. In some aspects, the edge update function is a sum, max or average. In some aspects, the edge update function is a weighted sum comprising attention-based weighted sum. In some aspects, the edge update function is a recurrent neural network.

In some aspects, the MLP can include a decoder, which reconstructs the input data represented as one or more graphs from the graph vector representation.

In some embodiments, methods can include preparing the generated predicted graph data (e.g., predicted label) as a real physical object. The object can be a picture, text, molecule, sound, video, or other object.

In some embodiments, a method of generating an object (e.g., real physical object, not a virtual object) can be performed based on the predicted label that is provided by the computer methods. The method can then include physical steps that are not implemented on a computer, including: selecting a predicted object; and obtaining a physical form of the selected predicted object. In some aspects, the object is a molecule. In some aspects, the method includes validating the molecule to have at least one characteristic of the molecule. For example, the molecule physical characteristics or bioactivity can be tested.

The method can also include generating a report that identifies the decoded object, which can be stored in a memory device or provided for various uses. The report can be used for preparing the physical real life version of the object. For example, the physical object can be obtained by synthesis, purchasing if available, extracting from plant or other composition, refining a composition or compound into the object, otherwise deriving the selected object as a real physical object.

In some embodiment, a computer system can include: one or more processors; and one or more non-transitory computer readable media storing instructions that in response to being executed by the one or more processors, cause the computer system to perform operations, the operations comprising the computer-implemented methods recited herein.

### Example

We applied proposed architecture on QM9, FreeSolv molecular datasets. QM9 is the quantum mechanics dataset which contains approximately 134k small molecules with up to 9 heavy atoms with calculated positions. This dataset provides 12 quantum chemical properties including dipole moment (mu), isotropic polarizability (alpha), highest occupied molecular orbital energy (HOMO), lowest unoccupied molecular orbital energy (LUMO), gap between HOMO and LUMO (gap), electronic spatial extent (R²), zero point vibrational energy (ZPVE), internal energy at OK (UO), internal energy at 298.15K (U), enthalpy at 298.15K (H), free energy at 298.15K (G), heat capacity at 298.15K (Cv). FreeSolv is the curated dataset provided by Free Solvation Database with hydration free energies calculated for 643 small neutral molecules. For each molecule graph structure, 14-19 atom features (atomic number, one-hot encoded atom type, donor or acceptor properties, one-hot encoded hybridization, aromaticity and the number of hydrogens) and 5 bond features (one-hot encoded bond type and bond length) were extracted. Atom positions were calculated for datasets where they were not provided. Edge adjacency matrix were precomputed to speed up the training process and utilize less memory. All feature extraction and data preprocessing was done with RDKit open source software.

The best results are reported for the best configurations of the proposed model on each dataset. The best hyperparameters were obtained with random search over a grid of hyperparameters, including hidden size, number of graph convolutional layers, number of layers in MLP, learning rate, batch size, dropout probability, whether to use GRU aggregation of hidden outputs, whether to add two-hop connections to the input graphs and number of epochs before early stopping.

For QM9 dataset the models were trained on 80% of the data and validated on 10%. Provided results are on the remaining 10% of the data. All 12 targets were normalized and the best model was trained in the multitask setting.

For FreeSolv dataset 20% of the data was reserved for testing, and models were trained using 10-fold cross validation on the remaining 80% of the data. Then mean metrics were calculated for models' predictions from the best configuration.

Results are provided as follows in Table 1 and Table 2. Table 1 provides the metrics on FreeSolv and mean metrics on QM9. Table 2 provides metrics for each target in QM9.

TABLE 1

| | MAE | MSE | RMSE | R2 |
|---|---|---|---|---|
| QM9 | 0.980985 | 29.806711 | 5.459552 | 0.986841 |
| FreeSolv | 0.521794 | 0.661364 | 0.809306 | 0.925616 |

TABLE 2

| | MAE | MSE | RMSE | R2 |
|---|---|---|---|---|
| mu | 0.3212184 | 0.2580701 | 0.508006 | 0.8879749 |
| alpha | 0.2179128 | 0.1173569 | 0.3425739 | 0.9982066 |
| HOMO | 0.0022823 | 0.0000108 | 0.0032912 | 0.9776021 |
| LUMO | 0.0023799 | 0.0000121 | 0.0034847 | 0.9944959 |
| gap | 0.003054 | 0.0000199 | 0.0044613 | 0.9911447 |
| R2 | 10.6032572 | 356.7008972 | 18.8865261 | 0.9954001 |
| ZPVE | 0.000286 | 0.0000004 | 0.0006543 | 0.9996099 |
| U0 | 0.1282787 | 0.142897 | 0.3780171 | 0.9999114 |
| U | 0.1283669 | 0.1429292 | 0.3780597 | 0.9999114 |
| H | 0.1283207 | 0.1427554 | 0.3778299 | 0.9999115 |
| G | 0.1283878 | 0.142735 | 0.3778029 | 0.9999115 |
| Cv | 0.1080831 | 0.0328475 | 0.1812388 | 0.9980086 |

Edge-Message Passing Neural Network (EMPNN) Model

An EMPNN model can include at least three base layers: graph convolutional layer, global graph pooling layer and multi-layer perceptron (MLP). These layers can be configured as computing modules. The graph convolutional layer can be described in terms of MPNN. The EMPNN architecture can be configured for edge message passing. The graph convolution layer can process the graph data by converting input graph edges into nodes, constructing new edges according to the edge adjacency matrix in the input graph and applying message passing to the resulting graph. Thus, an information related to pairs of edges can be passed to the model. The attention mechanism is used in the graph convolutional layer to impose it to learn important interrelations between atom pairs. The node and edge updates on step 1 is formulated as follows:

$${h}_{{i}_{2}}^{l + 1} = {V}_{1}^{i} {h}_{i}^{l} + {\sum }_{{j}_{2} ∼ {i}_{2}}^{ } Dropout ( {η}_{{i}_{2} {j}_{2}}^{l} ⊙ ( {W}_{1}^{l} {h}_{{i}_{1}}^{l} + {U}_{1}^{l} {e}_{{i}_{2} {j}_{2}}^{l} + {W}_{2}^{l} {h}_{{j}_{2}}^{l} ) )$$

$${η}_{{i}_{3} {j}_{3}}^{l} = \frac{exp ( {U}_{2}^{l} {e}_{{i}_{2} {j}_{2}}^{l} )}{{\sum }_{k ∼ {i}_{2}}^{ } exp exp ( {U}_{2}^{l} {e}_{{i}_{2} k}^{l} )}$$

$${e}_{{i}_{3}}^{l + 1} = {V}_{2}^{i} {e}_{{i}_{2}}^{l} + {\sum }_{{j}_{3} ∼ {i}_{3}}^{ } Dropout ( {T}^{l} {p}_{{i}_{3} {j}_{3}}^{l} + {U}_{2}^{l} {e}_{{i}_{2}}^{l} + {W}_{3}^{l} {h}_{k}^{l} + {U}_{3}^{l} {e}_{{j}_{2}}^{l} ) , k ∈ {i}_{2} ⋂ {j}_{2}$$

In these equations, h is node features; e is edge features; p is pair edge features; η is attention weights; T, U, V, and W are model weights. Note that a single-valued index is used for edge indexing instead of commonly used pair indices for the plain notation of adjacent edges.

Commonly used global graph pooling methods are unable to process edge features, however, it might be blended with node features after several message passing steps. In contrast, the proposed global graph pooling receives edge and/or node features, which yields more accurate graph embedding. Graph embedding is constructed via proposed global graph pooling as follows:

$${u}_{1} = {\sum }_{{i}_{2}}^{ } {h}_{{i}_{1}}^{l + 1} , \qquad {v}_{1} {\sum }_{{i}_{2}}^{ } {e}_{{i}_{2}}^{l + 1}$$

In these equations, V^{p} and W^{p} are pooling layer weights; u, v are embeddings of nodes and edges respectively; concat is an operation of joining embedding vectors; σ is a non-linear function.

Then, the graph embedding is simply fed into the MLP layer. The MLP layer can be configured and operated as a known MLP layer. The MLP layer outputs the predicted label, which can be updated graph data.

One skilled in the art will appreciate that, for the processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

In one embodiment, the present methods can include aspects performed on a computing system. As such, the computing system can include a memory device that has the computer-executable instructions for performing the methods. The computer-executable instructions can be part of a computer program product that includes one or more algorithms for performing any of the methods of any of the claims.

In one embodiment, any of the operations, processes, or methods, described herein can be performed or cause to be performed in response to execution of computer-readable instructions stored on a computer-readable medium and executable by one or more processors. The computer-readable instructions can be executed by a processor of a wide range of computing systems from desktop computing systems, portable computing systems, tablet computing systems, hand-held computing systems, as well as network elements, and/or any other computing device. The computer readable medium is not transitory. The computer readable medium is a physical medium having the computer-readable instructions stored therein so as to be physically readable from the physical medium by the computer/processor.

There are various vehicles by which processes and/or systems and/or other technologies described herein can be effected (e.g., hardware, software, and/or firmware), and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The various operations described herein can be implemented, individually and/or collectively, by a wide range of hardware, software, firmware, or virtually any combination thereof. In one embodiment, several portions of the subject matter described herein may be implemented via application specific integrated circuits (ASICs), field programmable gate arrays (FPGAs), digital signal processors (DSPs), or other integrated formats. However, some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and/or firmware are possible in light of this disclosure. In addition, the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a physical signal bearing medium include, but are not limited to, the following: a recordable type medium such as a floppy disk, a hard disk drive (HDD), a compact disc (CD), a digital versatile disc (DVD), a digital tape, a computer memory, or any other physical medium that is not transitory or a transmission. Examples of physical media having computer-readable instructions omit transitory or transmission type media such as a digital and/or an analog communication medium (e.g., a fiber optic cable, a waveguide, a wired communication link, a wireless communication link, etc.).

It is common to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. A typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems, including feedback loops and control motors (e.g., feedback for sensing position and/or velocity; control motors for moving and/or adjusting components and/or quantities). A typical data processing system may be implemented utilizing any suitable commercially available components, such as those generally found in data computing/communication and/or network computing/communication systems.

The herein described subject matter sometimes illustrates different components contained within, or connected with, different other components. Such depicted architectures are merely exemplary, and that in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include, but are not limited to: physically mateable and/or physically interacting components and/or wirelessly interactable and/or wirelessly interacting components and/or logically interacting and/or logically interactable components.

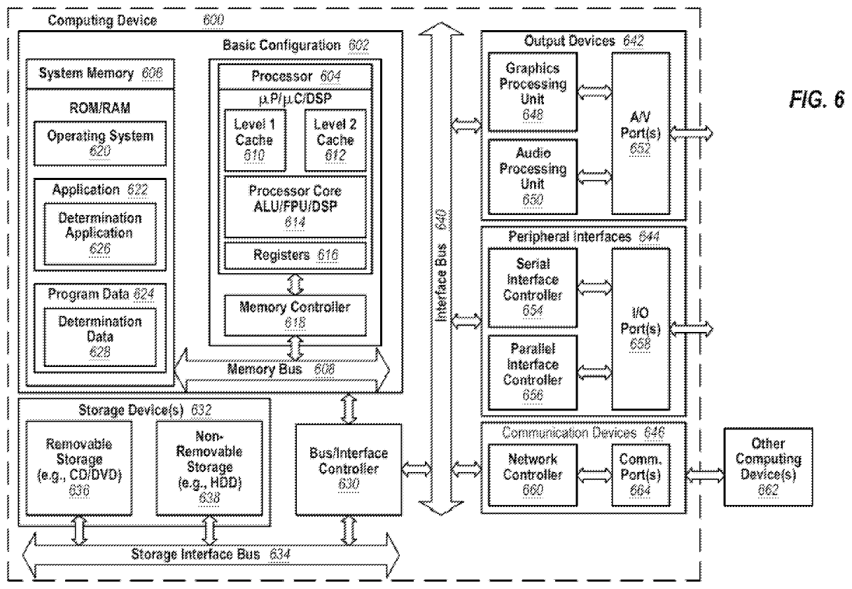

FIG. 6 shows an example computing device 600 (e.g., a computer) that may be arranged in some embodiments to perform the methods (or portions thereof) described herein. In a very basic configuration 602, computing device 600 generally includes one or more processors 604 and a system memory 606. A memory bus 608 may be used for communicating between processor 604 and system memory 606.

Depending on the desired configuration, processor 604 may be of any type including, but not limited to: a microprocessor (μP), a microcontroller (μC), a digital signal processor (DSP), or any combination thereof. Processor 604 may include one or more levels of caching, such as a level one cache 610 and a level two cache 612, a processor core 614, and registers 616. An example processor core 614 may include an arithmetic logic unit (ALU), a floating point unit (FPU), a digital signal processing core (DSP Core), or any combination thereof. An example memory controller 618 may also be used with processor 604, or in some implementations, memory controller 618 may be an internal part of processor 604.

Depending on the desired configuration, system memory 606 may be of any type including, but not limited to: volatile memory (such as RAM), non-volatile memory (such as ROM, flash memory, etc.), or any combination thereof. System memory 606 may include an operating system 620, one or more applications 622, and program data 624. Application 622 may include a determination application 626 that is arranged to perform the operations as described herein, including those described with respect to methods described herein. The determination application 626 can obtain data, such as pressure, flow rate, and/or temperature, and then determine a change to the system to change the pressure, flow rate, and/or temperature.

Computing device 600 may have additional features or functionality, and additional interfaces to facilitate communications between basic configuration 602 and any required devices and interfaces. For example, a bus/interface controller 630 may be used to facilitate communications between basic configuration 602 and one or more data storage devices 632 via a storage interface bus 634. Data storage devices 632 may be removable storage devices 636, non-removable storage devices 638, or a combination thereof. Examples of removable storage and non-removable storage devices include: magnetic disk devices such as flexible disk drives and hard-disk drives (HDD), optical disk drives such as compact disk (CD) drives or digital versatile disk (DVD) drives, solid state drives (SSD), and tape drives to name a few. Example computer storage media may include: volatile and non-volatile, removable and non-removable media implemented in any method or technology for storage of information, such as computer readable instructions, data structures, program modules, or other data.

System memory 606, removable storage devices 636 and non-removable storage devices 638 are examples of computer storage media. Computer storage media includes, but is not limited to: RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

Computing device 600 may also include an interface bus 640 for facilitating communication from various interface devices (e.g., output devices 642, peripheral interfaces 644, and communication devices 646) to basic configuration 602 via bus/interface controller 630. Example output devices 642 include a graphics processing unit 648 and an audio processing unit 650, which may be configured to communicate to various external devices such as a display or speakers via one or more A/V ports 652. Example peripheral interfaces 644 include a serial interface controller 654 or a parallel interface controller 656, which may be configured to communicate with external devices such as input devices (e.g., keyboard, mouse, pen, voice input device, touch input device, etc.) or other peripheral devices (e.g., printer, scanner, etc.) via one or more I/O ports 658. An example communication device 646 includes a network controller 660, which may be arranged to facilitate communications with one or more other computing devices 662 over a network communication link via one or more communication ports 664.

The network communication link may be one example of a communication media. Communication media may generally be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that includes any of the above functions. Computing device 600 may also be implemented as a personal computer including both laptop computer and non-laptop computer configurations. The computing device 600 can also be any type of network computing device. The computing device 600 can also be an automated system as described herein.

The embodiments described herein may include the use of a special purpose or general-purpose computer including various computer hardware or software modules.

Embodiments within the scope of the present invention also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media.

Computer-executable instructions comprise, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In some embodiments, a computer program product can include a non-transient, tangible memory device having computer-executable instructions that when executed by a processor, cause performance of a method that can include: providing a dataset having object data for an object and condition data for a condition; processing the object data of the dataset to obtain latent object data and latent object-condition data with an object encoder; processing the condition data of the dataset to obtain latent condition data and latent condition-object data with a condition encoder; processing the latent object data and the latent object-condition data to obtain generated object data with an object decoder; processing the latent condition data and latent condition-object data to obtain generated condition data with a condition decoder; comparing the latent object-condition data to the latent-condition data to determine a difference; processing the latent object data and latent condition data and one of the latent object-condition data or latent condition-object data with a discriminator to obtain a discriminator value; selecting a selected object from the generated object data based on the generated object data, generated condition data, and the difference between the latent object-condition data and latent condition-object data; and providing the selected object in a report with a recommendation for validation of a physical form of the object. The non-transient, tangible memory device may also have other executable instructions for any of the methods or method steps described herein. Also, the instructions may be instructions to perform a non-computing task, such as synthesis of a molecule and or an experimental protocol for validating the molecule. Other executable instructions may also be provided.

The attention mechanism allows ANNs to attend to different parts of input signals that it considers more relevant. After its success in Natural Language Processing tasks, this technique is widely used in modern ANNs.

The dropout is a function that drops out neurons with a given probability to reduce the effect of adaptation to the training data.

Batch normalization (BN) is a technique for improving the stability and speeding up the training process. It employs the normalization step on a small subset (batch) of data which fixes the means and variances of layer's inputs.

Embedding is a continuous vector representation of a discrete variable.

Autoencoders (AEs) are a type of ANN that can be used to construct hidden representations of the input data in an unsupervised setting. AEs include two parts: (1) one ANN that encodes the input signal (encoder); and (2) another ANN that reconstructs the input from the encoded vector (decoder). AEs often suffer from learning an identity function, therefore, different regularization techniques are applied to prevent it.

Generative Adversarial Networks (GANs) are a system of two ANNs, one of which generates samples (generator) while another ANN predicts whether they are real or generated (discriminator).

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

The present disclosure is to be limited only by the terms of the appended claims, along with the full scope of equivalents to which such claims are entitled. It is to be understood that this disclosure is not limited to particular methods, reagents, compounds compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” and the like include the number recited and refer to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

All references recited herein are incorporated herein by specific reference in their entirety.

1. A computer-implemented method of generating graph data, the method comprising:
processing input graph data with a graph convolution layer of an edge message passing neural network to obtain vector representations of the node data and edge data of the graph data;
processing the vector representations of the edge data and node data with a graph pooling layer of the edge message passing neural network that aggregates the vector representations of the node data and the vector representations of edge data to produce a vector representation of the input graph data;
processing the vector representation of the input graph data with a multi-layer perception layer of the edge message passing neural network to generate predicted graph data; and
outputting the predicted graph data in a report.

2. The computer-implemented method of claim 1, further comprising a graph neural network encoder of the graph convolution layer producing a vector representation for each node of the input graph and a vector representation for each edge of the input graph.

3. The computer-implemented method of claim 1, further comprising processing the input graph data to produce a vector representation for each node and a vector representation for each edge of the graphs.

4. The computer-implemented method of claim 1, further comprising processing the input graph data to produce a vector representation of the graphs.

5. The computer-implemented method of claim 1, further comprising processing the input graph data to produce a vector representation for each pair of nodes of the graphs.

6. The computer-implemented method of claim 1, further comprising processing the input graph data to produce a vector representation for each pair of edges of the graphs.

7. The computer-implemented method of claim 2, further comprising processing the input graph data with the graph neural network encoder in accordance with at least one of:
a node message neural network producing a vector representation for each pair of adjacent nodes based upon the vector representations of each node of the pair of adjacent nodes and a vector representation of each edge connecting the pair of adjacent nodes;
a node update neural network producing a vector representation of a node based upon a node representation and message vectors for node pairs formed by the node and its adjacent nodes;
an edge message neural network producing a vector representation for each pair of adjacent edges based upon the vector representations of each edge of the pair of adjacent edges and a vector representation of the common node of the pair of adjacent edges; or
an edge update neural network producing a vector representation of an edge based upon a node representation and message vectors for edge pairs formed by the edge and its adjacent edges.

8. The computer-implemented method of claim 1, further comprising the graph pooling layer aggregating the vector representations of nodes and the vector representations of edges to produce a vector representation of the input graph.

9. The computer-implemented method of claim 7, wherein the node update neural network is configured for one of a sum, max, or average.

10. The computer-implemented method of claim 7, wherein the node update neural network is configured for a weighted sum comprising an attention-based weighted sum.

11. The computer-implemented method of claim 7, wherein the node update neural network is a recurrent neural network.

12. The computer-implemented method of claim 7, wherein the edge update neural network is configured for one of a sum, max or average.

13. The computer-implemented method of claim 7, wherein the edge update neural network is configured for a weighted sum comprising an attention-based weighted sum.

14. The computer-implemented method of claim 7, wherein the edge update neural network is a recurrent neural network.

15. The computer-implemented method of claim 1, further comprising a decoder of the multi-layer perception layer reconstructing the input graph data represented as one or more graphs from the graph vector representation.

16. The computer-implemented method of claim 1, further comprising a generator that produces graphs from random noise.

17. The computer-implemented method of claim 1, wherein the at least one object is a picture, text, molecule, sound, video, or other object.

18. The computer-implemented method of claim 1, further comprising the graph convolution layer module performing:
processing the input graph data with a conversion operation;
converting input graph edges into new nodes;
constructing new edges to obtain resulting graph data; and
applying a messaging passing protocol with the resulting graph data.

19. The computer-implemented method of claim 1, further comprising the graph pooling layer module performing:
receiving edge features and node features as vectors; and
performing graph embedding of the vectors to produce a vector representation of new graph data.

20. A method of preparing providing an object, wherein the object is a physical object, an audio object, a text object or a color object, the method comprising:
obtaining the predicted graph data of the object of claim 1;
preparing the predicted graph data into a predicted object, wherein the predicted object is a physical object, an audio object, a text object or a color object.

21. A computer system comprising:
one or more processors; and
one or more non-transitory computer readable media storing instructions that in response to being executed by the one or more processors, cause the computer system to perform operations, the operations comprising:
processing input graph data with a graph convolution layer of an edge message passing neural network to obtain vector representations of the node data and edge data of the graph data;
processing the vector representations of the edge data and node data with a graph pooling layer of the edge message passing neural network that aggregates the vector representations of the node data and the vector representations of edge data to produce a vector representation of the input graph data;
processing the vector representation of the input graph data with a multi-layer perception layer of the edge message passing neural network to generate predicted graph data; and
outputting the predicted graph data in a report.

22. One or more non-transitory computer readable media storing instructions that in response to being executed by the one or more processors, cause the computer system to perform operations, the operations comprising:
processing input graph data with a graph convolution layer of an edge message passing neural network to obtain vector representations of the node data and edge data of the graph data;
processing the vector representations of the edge data and node data with a graph pooling layer of the edge message passing neural network that aggregates the vector representations of the node data and the vector representations of edge data to produce a vector representation of the input graph data;
processing the vector representation of the input graph data with a multi-layer perception layer of the edge message passing neural network to generate predicted graph data; and
outputting the predicted graph data in a report.
